(19) United States
(12) Patent Application Publication
(10) Pub. No.: US 2003/0108846 A1
(43) Pub. Date: Jun. 12, 2003

(54) Disposable oral hygiene device and methods of making same

(75) Inventor: Kim Marie Hoertsch, Neenah, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/010,511

(22) Filed: Dec. 6, 2001

(51) Int. Cl. A61C 17/00

(52) U.S. Cl. 433/216; 15/104.94; 15/209.1; 15/210.1; 15/118; 15/223; 15/225; 300/21; 604/1

(57) ABSTRACT

A disposable, hand-held oral hygiene device comprising an elongated member and one or more swabs attached to one or both longitudinal ends of the elongated member. The swab can comprise a material suitable for cleaning the teeth and mouth. In particular embodiments, this material is a nonwoven fabric having projections. The elongated member can be sufficiently compressible to prevent harm to the care receiver in the event the care receiver bites down while receiving care. For example, the elongated member can have a compressive energy of from about 2 to about 20 inch-pounds (from about 0.226 to about 2.26 Joules). The present invention further describes various methods of making a disposable oral hygiene device.

### FIELD OF THE INVENTION

This invention is directed to a disposable oral hygiene device used to clean the teeth and mouth. More specifically, this invention relates to the special needs present when one individual is providing oral hygiene care to another.

### BACKGROUND OF THE INVENTION

Oral hygiene care is frequently performed upon one individual by another. For example, dental professionals must often clean the teeth and mouth of patients during the delivery of dental care. In another example, many individuals, due to incapacitation, debilitation, sedation, or other lack of muscular control, are unable to care for their own teeth, to rinse out their own mouths, or to otherwise maintain adequate oral hygiene. As a result, these individuals rely upon others to provide the necessary oral hygiene care.

Providing oral hygiene care to others can be challenging. Reaching and cleaning hard-to-reach and obstructed areas of the mouth is difficult. Patients suffering various afflictions may have sensitive or bleeding tissues within their mouth, rendering conventional oral care methods such as nylon-bristle toothbrushes unsuitable. Odor from an unclean mouth can be strong and nauseating for the caregiver. Further, patients are often uncooperative and can't or won't open their mouths. Often, patients either intentionally or involuntarily bite down while receiving oral hygiene care, presenting danger both to themselves and to those providing care.

There has long existed a need for a device addressing these considerations. For sanitary and convenience reasons, it is desirable that such a device be low enough in cost so as to be disposable.

Various devices have been proposed to meet both the needs of individuals who rely on others for oral hygiene care as well as the needs of the persons providing the care. Most of these devices utilize a sponge-like substance for the cleaning element. For example, a device marketed as TOOTHETTE®, a registered trademark of Sage Products, Inc., constitutes a piece of foam sponge attached to the end of a hard, stiff handle, similar to a “lollipop stick.” Another, similar device includes a sponge-like material containing a dentifrice within its pores. Other devices consist of a woven cotton fabric or pulp-based tissue paper attached to the end of a handle made of wood or a similar material, akin to a flat, wooden “Popsicle® stick.” Still other devices include an applicator swab having an abrasive terrycloth head.

However, these and other known devices are problematic. First, none of the disposable devices proposed to date include a cleaning member that provides adequate cleaning ability. Notably, the foam sponge material employed by many of the prior art devices are not sufficiently “textured” to adequately remove residue and debris from the teeth, gums, tongue, and other areas of the mouth. Second, none include a handle that is soft and that may safely absorb the compressive force of a bite in the event that the care receiver bites down while receiving care. Third, none include a handle long enough to allow the caregiver to reach the rear of the oral cavity while at the same time keeping his or her hand safely away from the care receiver's teeth. Traditional toothbrushes having tufts of nylon bristles provide good cleaning ability, but typically have a hard, stiff handle, have bristles which may be too stiff and harsh to use on sensitive tissue, and, even if manufactured so as to be “disposable,” are typically still prohibitively expensive.

Hence, despite the various past proposals, no disposable oral hygiene device is presently known that provides adequate cleaning ability, is both convenient and safe to both the caregiver and care receiver, and is low enough in cost so as to be disposable after one use.

### SUMMARY OF THE INVENTION

In response to the discussed difficulties and problems encountered in the prior art, a new disposable oral hygiene device has been invented.

One aspect of this invention relates to a disposable oral hygiene device having an elongated member and one or more swabs secured thereto. In one particular embodiment, each swab is constructed of a nonwoven fabric suitable for cleaning the teeth and mouth. In another particular embodiment, the elongated member is comprised of a thermoplastic material and has a compressive energy of from about 0.226 Joules to about 2.26 Joules. In another particular embodiment, the elongated member is hollow, is comprised of a polypropylene material, has a compressive energy of from about 0.452 Joules to about 0.791 Joules, and has a wall thickness of from about 0.35 millimeters to about 0.50 millimeters, and each swab is constructed of a nonwoven fabric, the fabric comprising overlapping thermoplastic fibers defining an array of hollow projections protruding from the fabric.

Another aspect of this invention relates to a process of providing oral hygiene care. In one particular embodiment, the process comprises providing a disposable oral hygiene device having an elongated member and one or more swabs secured thereto wherein each swab is constructed of a nonwoven fabric, and cleaning a mouth with the disposable oral hygiene device. In another particular embodiment, the process comprises providing a disposable oral hygiene device having a hollow elongated member having a first end and a second end, the elongated member comprised of a polypropylene material, the elongated member having a compressive energy of from about 0.452 Joules to about 0.791 Joules, and the elongated member having a wall thickness of from about 0.35 millimeters to about 0.50 millimeters, and wherein a swab is secured to the first end, the swab comprising a nonwoven fabric, the fabric comprising overlapping thermoplastic fibers defining an array of hollow projections protruding from the fabric, and cleaning a mouth with the disposable oral hygiene device.

Still another aspect of this invention relates to methods of making a disposable oral hygiene device. In one particular embodiment, the method involves folding a fabric over an end of an elongated member to create a first layer and a second layer such that the elongated member is sandwiched between the first layer and the second layer, securing the fabric to the elongated member, and securing the first layer to the second layer. In another particular embodiment, the method involves winding a fabric around an end of an elongated member in a direction perpendicular to a longitudinal axis of the elongated member, and securing the fabric to the elongated member.

### BRIEF DESCRIPTION OF SEVERAL VIEWS OF THE DRAWINGS

FIG. 1 is a perspective view of one embodiment of the device of the present invention, with portions broken away for purposes of illustration.

FIG. 2 is a section view of the device of FIG. 1 taken from the plane of line 2-2 in FIG. 1.

FIG. 3 is a perspective view of an alternative embodiment of the device of the present invention.

FIG. 4 is a perspective view of another alternative embodiment of the device of the present invention.

FIG. 5 is a plan view of another alternative embodiment of the device of the present invention.

FIG. 6 is a perspective view of one embodiment of a nonwoven fabric according to the present invention.

FIG. 7 is a side view of the device of FIG. 1 in a compressed position.

FIG. 8 is a side view of another alternative embodiment of the device of the present invention.

FIG. 9 is a side view of the device of FIG. 8 in a bent position.

FIG. 10 is a side view of another alternative embodiment of the present invention.

FIG. 11 is a side view of another alternative embodiment of the present invention.

FIGS. 12 and 13 are perspective views illustrating a method of making one embodiment of the disposable oral hygiene device of the present invention.

FIGS. 14 and 15 are perspective views illustrating an alternative method of making one embodiment of the disposable oral hygiene device of the present invention.

FIG. 16 is an end view of the method and step of FIG. 15.

### DETAILED DESCRIPTION OF THE PREFERRED EMBODIMENTS

The disposable oral hygiene device of the present invention, used to clean the teeth, tongue, and inner mouth, delivers desirable safety, efficiency, health, and cost benefits to users of disposable oral hygiene care products. “Disposable” as used herein includes being disposed of after use and not intended to be washed and reused. While beneficial to all users of disposable oral hygiene products, the present device is especially useful in those settings in which one individual performs oral hygiene care activities upon another, including, for example, professional dental care settings, cases involving incapacitated persons and others unable to conduct adequate oral hygiene activity upon themselves, pet care situations, and the like.

As representatively illustrated in FIGS. 1-4, the disposable oral hygiene device 20 generally can include a swab 50 secured to an elongated member 30. As more fully developed below, the swab 50 can be designed such that its surface, size, shape, and other characteristics enhance the device's cleaning properties. Further, the elongated member 30 can be designed such that its structural composition, mechanical properties, shape, size, and other characteristics maximize the device's cleaning effectiveness while at the same time ensuring the safety of both caregiver and care receiver.

As representatively illustrated in FIGS. 1-4, the disposable, hand-held, oral hygiene device 20 of the present invention can include among its elements a swab 50 suitable for cleaning teeth, gums, and the mouth in general. The swab 50 can be constructed of any material suitable for such use, including such materials as, for example, cotton, rayon, wood pulp, polymeric substances such as nonwoven fabrics, foam sponges, thermoplastics, or the like. The swab 50 defines an outer surface 51 which can be smooth or rough, and may contain tufts, ridges, projections or other topographical characteristics giving the outer surface 51 a three-dimensional character, thereby imparting the desired cleaning properties to the device 20. In particular embodiments, the outer surface 51 can be textured to facilitate removal of residue and film from the teeth, gums, tongue, and other areas of the mouth.

The swab 50 can, in particular embodiments, be composed at least in part of a nonwoven fabric. As used herein, the term “nonwoven fabric” refers to a web or fabric, made partly or wholly of non-cellulosic material, having a structure of individual fibers or threads which are interlaid, but not in an identifiable manner as in a knitted fabric. Nonwoven webs or fabrics have been formed from many processes, such as, for example, meltblowing processes, spunbonding processes, and bonded carded web processes. In particular embodiments, nonwoven fabrics as utilized in the present invention are produced from polymers, such as, for example, polyethylene or polypropylene. Nonwoven webs used in the present invention can include a textured surface to improve the device's cleaning ability as earlier mentioned. Nonwoven webs having textured surfaces are known in the art, any of which could be utilized in the construction of the swab 50. Examples of known nonwoven, textured materials include rush transfer materials, flocked materials, wireform nonwovens, thermal point unbonded materials, and the like.

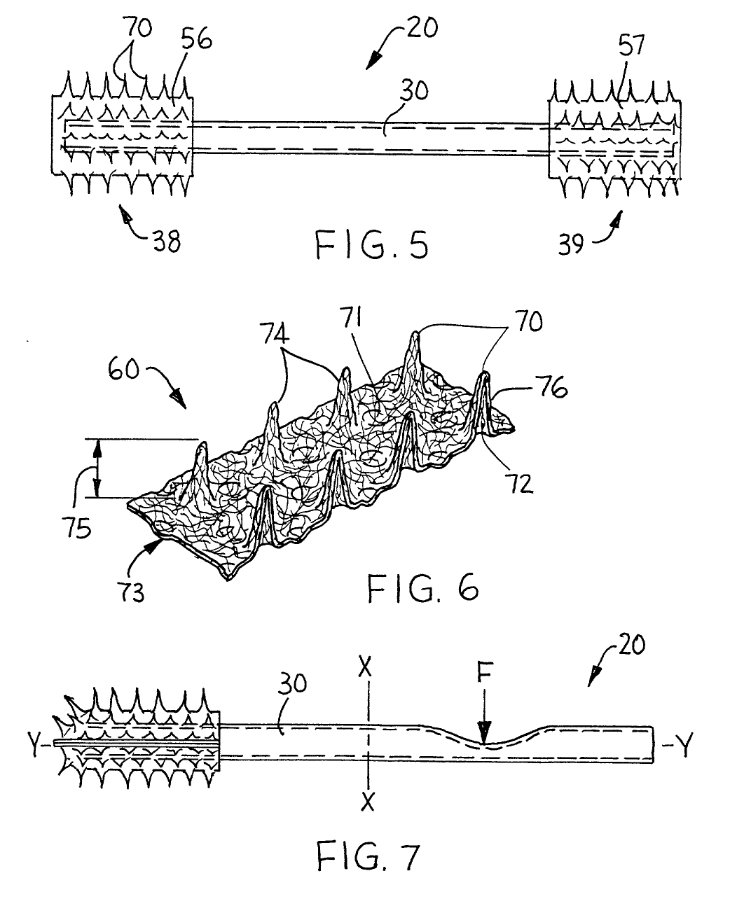

Referring to FIG. 6, the swab in selected embodiments can be constructed of a nonwoven fabric 60 made of an array of interbonded thermoplastic fibers. The term “fibers” as used herein refers to a broad range of thermoplastic members that can be used to form a nonwoven fabric, including members having defined lengths like staple fibers, meltblown fibers that show a beginning and an end, filaments having endless or continuous lengths, and the like. The raw materials used to make the nonwoven fabric 60 may be selected from a wide variety. For example, and without limiting the generality of the foregoing, thermoplastic polymers such as polyolefins including polyethylene, polypropylene as well as polystyrene can be used as may be polyesters including polyethylene terephthalate, and polyamides including nylons. Also useful are other thermoplastic polymers such as those which are elastomeric including elastomeric polyurethanes and block copolymers. Compatible blends of any of the foregoing may also be used. In addition, additives such as wax, fillers, and the like may be incorporated in amounts consistent with the fiber forming process used to achieve desired results. Other fiber or filament forming materials will suggest themselves to those skilled in the art. Bicomponent fibers may be used. The fibers may also be formed from solution, and examples include viscose. It is only essential that the composition be capable of spinning into filaments or fibers of some form that can be deposited onto a forming surface and thermally formed or interbonded in a manner dependent upon the forming surface.

Since most of these polymers are hydrophobic, if a wettable surface is desired, known compatible surfactants may be added to the polymer as is well known to those skilled in this art. The term “wettable” as used herein means that a material is more hydrophilic than hydrophobic. Such surfactants can include, by way of example and not limitation, anionic and nonionic surfactants such as sodium dioctyl sulfosuccinate (Aerosol OT available from American Cyanamid, Parsippany, N.J., U.S.A.); alkyl phenoxy ethanol (Triton® X-100 available from the Rhom & Haas Company, Philadelphia, Pa., U.S.A.); a blend of about 50 weight percent sorbitan mono-oleate and about 50 weight percent hydrogenated ethoxylated castor oil at 100 percent solids (Ahcovel®) Base N-62 surfactant available from ICI Chemicals, Wilmington, Del.); and an alkyl polyglycoside with a C8-10 chain at 60 percent solids (Glucopon® UP-220 available from Henkel Chemicals). Other additives such as pigments, fillers, stabilizers, and the like may also be incorporated. Further discussion of the use of such additives may be had by reference to U.S. Pat. No. 4,374,888 issued to Bornslaeger dated Feb. 22, 1983, for example, and U.S. Pat. No. 4,070,218 issued to Weber dated Jan. 24, 1978. Preferably, the surface of the fabric 60 is wettable so as to improve the ability of the disposable oral hygiene device 20 to attract water, saliva, and other liquids and to attract debris within the mouth for easier removal during cleaning. The amount of surfactant additive can be adjusted to impart the desired level of wettability to the surface of the fabric 60.

The basis weight for the nonwoven fabric 60 may vary depending upon functional, cost, or manufacturing objectives. For example, the basis weight of the nonwoven fabric 60 may be as low as 10 grams per square meter, or as high as 300 grams per square meter. The nonwoven fabric 60 as used in the disposable oral hygiene device 20 can have a basis weight of from about 10 grams per square meter to about 300 grams per square meter, and more particularly from about 50 grams per square meter to about 100 grams per square meter.

The nonwoven fabric 60 may have a smooth or rough surface texture. In particular embodiments, the topography of the nonwoven fabric is three-dimensional in character so as to enhance the cleaning properties of the device 20. For example, as representatively illustrated in FIG. 6, the nonwoven fabric can define a base plane 73 and raised areas 74, such that the raised areas 74 protrude from the base plane 73, imparting a three-dimensional character to the topography of the nonwoven fabric 60, thereby enhancing the cleaning properties of the swab 50. These raised areas 74 can take the form of tufts, ridges, projections, or the like. In one particular embodiment, the nonwoven fabric 60 contains projections 70, as representatively illustrated in FIGS. 1-11, to improve the cleaning ability of the device 20. The number of projections 70 in such a fabric may vary widely depending upon the functional, cost, or manufacturing objectives involved. For example, the number of projections 70 can be from one per square centimeter to about eighty per square centimeter. More particularly, the number of projections 70 as used in the disposable oral hygiene device 20 of the present invention can be from about two to about 50 per square centimeter, and still more particularly from about eight to about 25 per square centimeter.

The shape of the individual projections 70 will vary depending upon how they are formed. In particular embodiments of the disposable oral hygiene device 20 of the present invention, the projections can be substantially hollow and have a height 75 in the range of from about 0.3 millimeter to about 25 millimeters, more particularly from about 0.5 millimeter to about 10 millimeters, and still more particularly from about 2 millimeters to about 8 millimeters to provide the improved oral hygiene properties. The term “hollow” as used herein to describe the projections 70 does not completely exclude the presence of fibers or filaments in core areas 72 of the projections 70. On the contrary, as will be apparent to those skilled in this art, fabric-manufacturing processes may well leave fibers in the core areas 72 due to variabilities in airflow, fiber properties or other parameters. The term “hollow” as used herein, therefore, means that the core or centerline taken through a given projection will define a low density path substantially free from fibers or filaments when compared with the land areas 71 or projection walls 76.

In one embodiment of the nonwoven fabric 60 having projections 70, the fibers or filaments in the projections 70 are oriented in a parallel direction to a higher degree than those fibers or filaments in the land areas 71. This can result from the pressure differential applied to the fibers either as the fibers or filaments are pulled over the projections on the forming surface or drawn through apertures in the forming surface. The result, in either case, is that the alignment will be at least 5 degrees greater in the projections 70 than in the land areas 71.

The fibers or filaments used to produce the nonwoven fabrics of the present invention may vary widely in shape, diameter, cross-section, and length. For example, continuous spunbond filaments may be used as well as meltblown continuous or discontinuous microfibers which frequently have a lower average diameter. Furthermore, additives to the web such as superabsorbent powders, liquids, or natural fibers such as wood pulp may also be incorporated at various loading levels depending upon desired properties of oral hygiene care.

Examples of a nonwoven web having projections suitable for use in the disposable oral hygiene device 20 are described in U.S. Pat. No. 4,741,941, entitled “Nonwoven Web With Projections,” issued to Englebert et al. on May 3, 1988, the disclosure of which is herein incorporated by reference and made a part hereof.

The swab 50 of the disposable oral hygiene device 20 may take a variety of shapes. Representative examples of such shapes include cylinders, spheres, cones, pyramids, any hourglass-type shape, any species of polyhedron, any egg-type shape, any shape having ends which come to a point, and the like, including any combination or variation of the foregoing. FIGS. 1-4 representatively illustrate examples of desirable shapes of the swab 50.

The dimensions of the swab 50 may vary greatly. Ideally, the swab 50 is dimensioned such that it is small enough to easily fit within the care receiver's mouth and into areas between the teeth and cheeks, but large enough to provide ample surface for cleaning and debris removal. For example, if the swab 50 has the shape representatively illustrated in FIG. 1, the swab 50 can have a length 52 from about 15 millimeters to about 60 millimeters, more particularly from about 30 millimeters to about 50 millimeters, and still more particularly from about 35 millimeters to about 45 millimeters. The embodiment pictured in FIG. 1 further can have a width 53 of from about 10 millimeters to about 40 millimeters, more particularly from about 20 millimeters to about 40 millimeters, and still more particularly from about 25 millimeters to about 35 millimeters. In an embodiment such as that representatively illustrated in FIG. 4, wherein the swab 50 is generally cylindrical in shape, the swab 50 can have a length 52 from about 15 millimeters to about 60 millimeters, more particularly from about 30 millimeters to about 50 millimeters, and still more particularly from about 35 millimeters to about 45 millimeters. The embodiment pictured in FIG. 4 further can have a diameter 54 from about 10 millimeters to about 25 millimeters, and more particularly from about 12 millimeters to about 18 millimeters.

The disposable oral hygiene device 20 invention can have a swab 50 at merely one end of the elongated member 30 (FIGS. 1-4), or, as representatively illustrated in FIG. 5, can have a first swab 56 secured to a first end 38 and a second swab 57 secured to a second end 39. In such an embodiment, the first swab 56 and the second swab 57 can be of the same shape, size, and material, or can differ in one or more of these aspects.

The disposable oral hygiene device 20 also includes an elongated member 30. The elongated member functions both as a handle and as a chassis to which one or more swabs 50 are secured.

The cross-sectional shape of the elongated member 30 may take a variety of forms, including, but not limited to, a circle, an oval, a rectangle or other polygon, and the like. For example, the elongated member 30 may have a circular cross-sectional shape as representatively illustrated in FIGS. 1-4. The elongated member 30 has a length 32, which may vary depending upon the particular objective to be met with the device. In selected embodiments, the elongated member 30 is long enough to allow the caregiver to access the rear of the care-receiver's mouth while keeping the caregiver's hand safely away from the care-receiver's mouth in general and teeth in particular, but short enough to allow the caregiver to exert pressure on the care-receiver's teeth and mouth sufficient to adequately clean the teeth and mouth without causing the elongated member 30 to bend or bow excessively. For example, the elongated member 30 as representatively illustrated in FIG. 1 can have a length 32 from about 15 centimeters to about 30 centimeters, more particularly from about 18 centimeters to about 25 centimeters, and still more particularly from about 19 centimeters to about 23 centimeters.

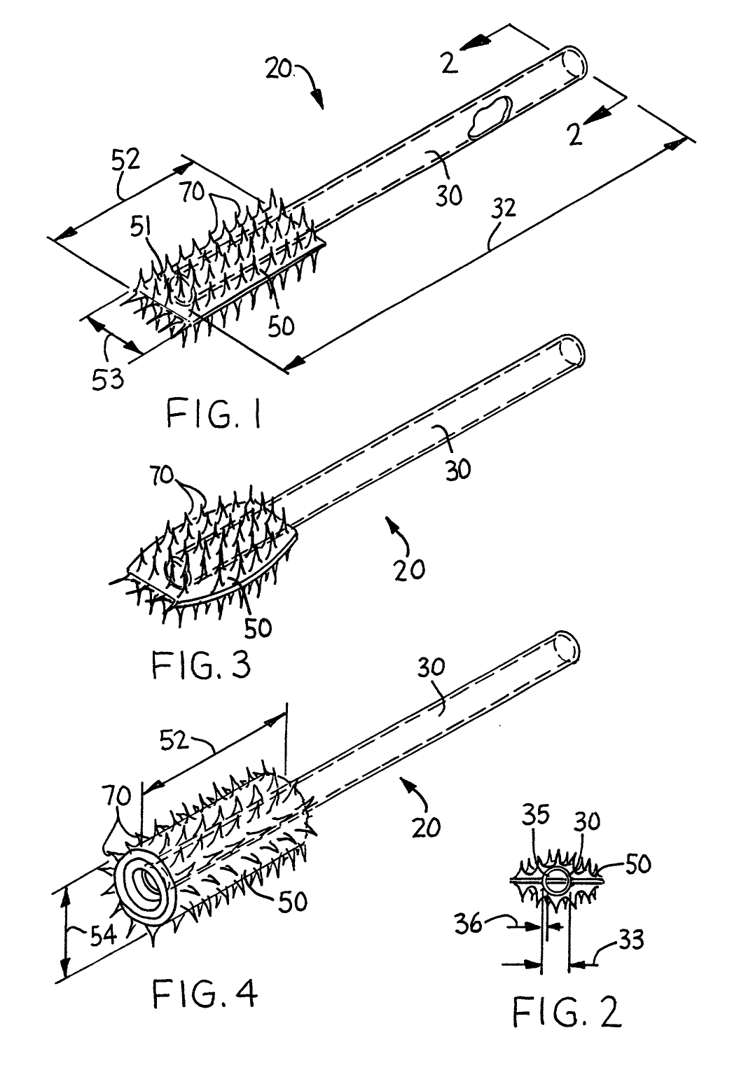

The width or outer diameter of the elongated member 30 may vary depending upon functional and manufacturing objectives. In selected embodiments, the elongated member 30 is narrow enough to allow the caregiver to easily access all areas of the care-receiver's mouth, but wide enough to give the elongated member sufficient rigidity in order to allow the caregiver to exert pressure on the care-receiver's teeth and mouth sufficient to adequately clean the teeth and mouth without causing the elongated member 30 to bend or bow excessively. In one desirable embodiment, as representatively illustrated in FIG. 2, wherein the elongated member is cylindrical in shape, the elongated member 30 has an outer diameter 33 of from about 3 millimeters to about 8 millimeters and more particularly from about 4 millimeters to about 6 millimeters.

The elongated member 30 may be made of any type of material suitable for use in a disposable oral hygiene device. Preferably, the material is non-toxic, low in cost, hygienic, pleasant tasting, and presents no dangers to the teeth of the care receiver in the event that the care receiver bites down while receiving care. Examples of suitable materials include, but are not limited to, polyethylene, polypropylene, and similar, soft, thermoplastic materials. In some embodiments, at least one part of the elongated member may be softer or less stiff than other parts. An important element of the device 20 is the ability of the elongated member 30 to easily compress in a generally latitudinal or radial direction (representatively illustrated by force vector “F” in FIG. 7) so as to reduce the likelihood of tooth damage and pain to the care receiver in the event that the care receiver bites down while receiving care, while at the same time maintain sufficient rigidity in the longitudinal direction so as to resist bending or excessive bowing during the caregiving process. For example, if an elongated member 30 is subjected to the compression test described below, the elongated member, in particular embodiments, can exhibit a compression energy of from about 2 inch-pounds (about 0.226 Joules) to about 20 inch-pounds (about 2.26 Joules), more particularly from about 3 inch-pounds (about 0.339 Joules) to about 10 inch-pounds (about 1.13 Joules), and still more particularly from about 4 inch-pounds (about 0.452 Joules) to about 7 inch-pounds (about 0.791 Joules).

The elongated member 30 may be solid, hollow, or partially solid and hollow. In particular embodiments, the elongated member 30 is hollow to allow it to easily flex in a generally latitudinal or radial direction in the event that the care receiver bites down while receiving care, thereby reducing the likelihood of either pain or tooth damage to the care receiver. Referring to FIG. 2, a hollow elongated member 30 includes a wall 35 having a wall thickness 36. The term “hollow” as used herein to describe the elongated member 30 means that the area contained within the wall 35 is a substantially unfilled space. In particular embodiments, the wall thickness 36 is great enough to provide sufficient longitudinal rigidity as mentioned earlier, yet low enough to provide radial compressibility sufficient to meet the aforementioned safety concerns. Further, the wall thickness 36 will depend upon the particular objective of the device, the raw material used to make the elongated member 30, the dimensions of the elongated member 30, and other factors. For example, if the elongated member 30 is hollow, constructed of polypropylene, and about 20 centimeters in length, the wall thickness 36 can be from about 14 mils (about 0.356 mm) to about 20 mils (about 0.508 mm), more particularly from about 15 mils (about 0.381 mm) to about 19 mils (about 0.483 mm), and still more particularly from about 16 mils (about 0.406 mm) to about 18 mils (about 0.457 mm). Further, the elongated member may have different properties in different regions. For example, the elongated member can be hard or stiff in one region, but soft or flexible in another region.

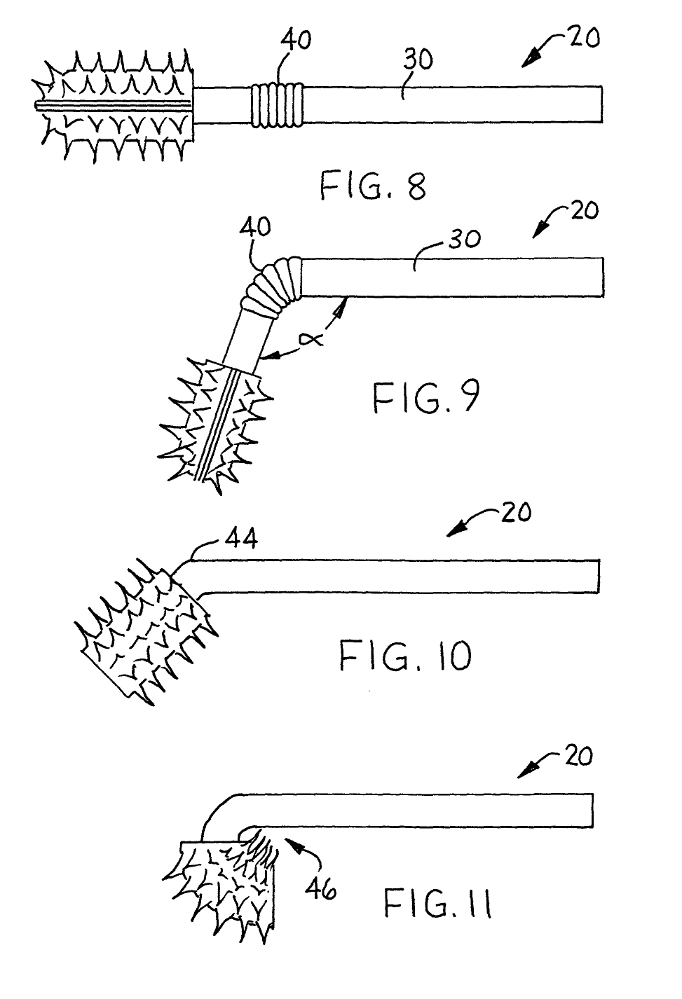

Referring to FIGS. 8 and 9, the elongated member 30 can also include a hinge 40. The hinge 40 allows a caregiver to bend the elongated member 30 so as to create an angle a as representatively illustrated in FIG. 9. Such an angle α allows the caregiver to more easily reach obstructed areas of the mouth, in the nature of a professional dental instrument. In selected embodiments, the hinge 40 is designed such that, once bent into position by the caregiver, the elongated member 30 will maintain such bent position and angle α during the caregiving process.

Referring to FIGS. 10 and 11, the elongated member 30 can also include one or more pre-formed bends or hooks to allow a caregiver to more easily reach obstructed areas of the mouth, in the nature of a professional dental instrument. The term “bend” as used herein refers to an angular turn of any degree along the length of the elongated member. FIG. 10 representatively illustrates a pre-formed bend 44 in the elongated member 30. The term “hook” at used herein refers to an arcuate portion of any size along the length of the elongated member. FIG. 11 representatively illustrates a pre-formed hook 46 in the elongated member 30. Such bends or hooks are formed during the manufacture of the elongated member 30, and can be either permanent or nonpermanent.

In another embodiment of the device 20, the swab 50 includes a dentifrice. The term “dentifrice” as used herein refers to pastes, powders, or liquids known in the art used for cleaning the teeth, gums, tongue, or other areas inside the mouth, and can also include other materials with which the swab might be impregnated to enhance its cleaning properties, such as water, humectants, scouring powders, thickening agents, aromas, preservatives, and the like. The dentifrice may be applied to the swab 50 at any point in time. For example, the dentifrice may be applied to the swab 50 by a caregiver just prior to delivering oral hygiene care, or may be pre-applied to the swab. The term “pre-applied” is used herein to refer to application during a manufacturing stage, such as during the assembly of the disposable oral hygiene device 20, or during the manufacture of the material or fabric constituting the swab 50, or any other point in time prior to sale of the device 20. If the disposable oral hygiene device 20 includes both a first swab 56 and a second swab 57 as representatively illustrated in FIG. 5, the dentifrice 80 can be applied to one or both swabs, or different dentifrices can be applied to either end. In one desirable version of this embodiment having both a first swab 56 and a second swab 57, the dentifrice is applied only to the first swab 56. Such a design allows one end of the disposable oral hygiene device 20 to be used to apply the dentifrice to the teeth and to massage it thereto, and allows the other end to be used to remove the dentifrice, debris, and other substances from the teeth and mouth.

Another aspect of the present invention is directed to methods for making a disposable oral hygiene device 20 utilizing a fabric 90.

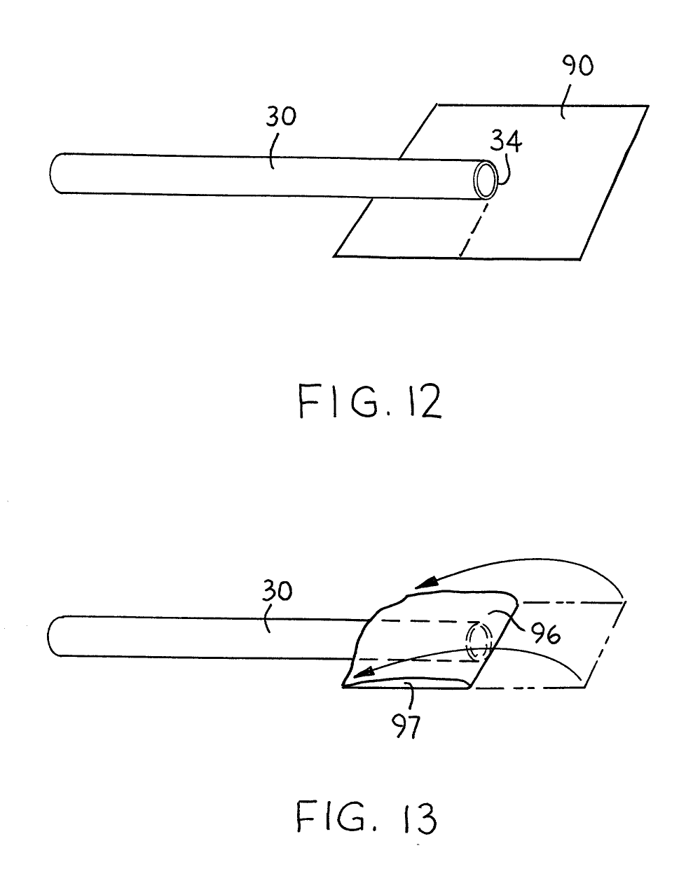

Referring to FIGS. 12 and 13, in one method, a fabric portion 90 is folded over a first end 34 of the elongated member 30, thus creating a first layer 96 and a second layer 97, and such that the elongated member 30 is sandwiched between the first layer 96 and the second layer 97. At some point, the first layer 96 is secured to the second layer 97, and both the first layer 96 and the second layer 97 are secured to the elongated member 30. The term “secure” as used herein means to permanently bond and is used interchangeably with the term “bond.” Any of the bonding steps or portions thereof may occur at any time in the manufacturing process. For example, one or more parts of the necessary bonding steps may occur prior to folding the fabric 90. Methods suitable for the bonding requirements described in this method are well known to those skilled in the art and include such methods as, for example, adhesive bonding, thermal bonding, ultrasonic bonding, and the like.

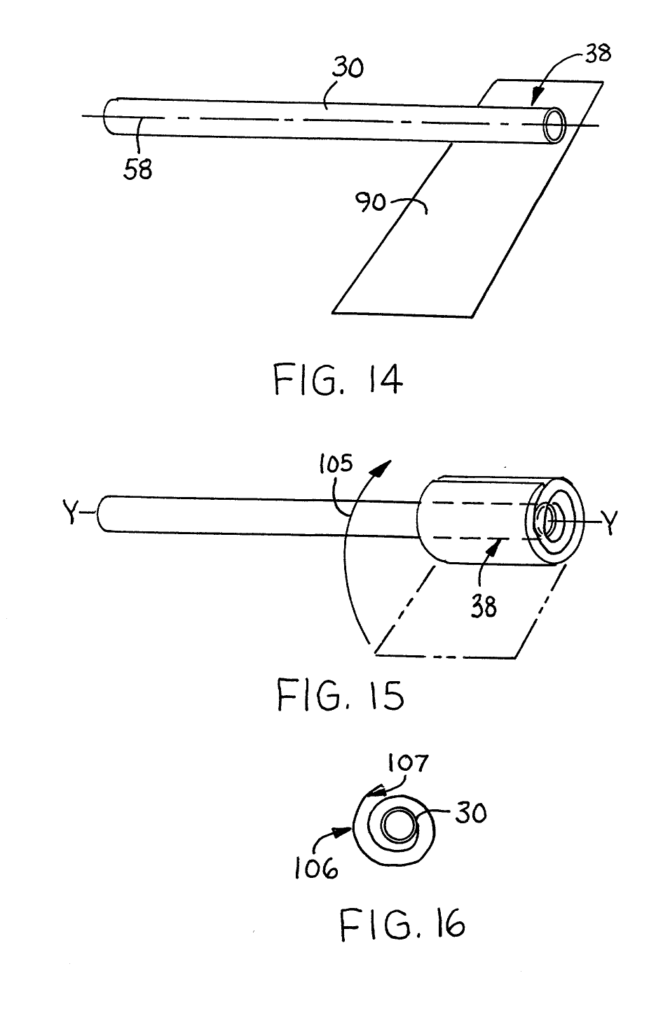

Referring to FIGS. 14-16, in another method of making a disposable oral hygiene device, the fabric 90 is wound around the first end 38 of the elongated member 30. The terms “wound” or “winding” as used herein refers to wrapping the fabric 90 around the elongated member 30 in a direction generally perpendicular to a longitudinal axis Y-Y of the elongated member 30, indicated by reference numeral 105. At some point, the fabric 90 is secured to the elongated member 30, and the fabric 90 may, if needed, be secured to itself as it is wound around the elongated member 30 so as to create a bound swab about the elongated member 30. Any of the bonding steps or portions thereof may occur at any time in the manufacturing process. In one example, the elongated member 30 is bonded to one or more regions of the fabric 90. Following this, the fabric 90 is wrapped around the elongated member 30 in a direction indicated by reference numeral 105, creating a first surface 106 facing away from the elongated member 30 and a second surface 107 facing towards the elongated member 30. As the fabric 90 is wrapped around the elongated member 30, the second surface 107 (that which is inward-facing) is bonded to the underlying surface of the elongated member 30. If the fabric 90 is of a size such that it is wrapped around the elongated member 30 more than once, the second surface 107 (that which is inward-facing) is bonded to the first surface 106 (that which is outward-facing) of underlying layers of the fabric portion 90. Methods suitable for the bonding requirements described in this method are well known to those skilled in the art and include such methods as adhesive bonding, thermal bonding, ultrasonic bonding, and the like.

While the invention has been described in detail with respect to specific embodiments thereof, it will be appreciated that those skilled in the art, upon attaining an understanding of the foregoing, may readily identify alteration to, variations of and equivalents to these embodiments.

Accordingly, the scope of the present invention should be assessed as that of the appended claims and any equivalents thereto.

### Elongated Member Compression Test

The elongated-member compression test was performed on an MTS Synergie Model 100 tensile testing machine equipped with a computer-based control and data acquisition system running MTS TestWorks 3.10 software (available through MTS Corporation, Eden Prairie, Minn.). A software-deflection-compensated 500N load cell was used for this test. Circular compression platens were attached to the load cell and the base of the tensile machine. The upper platen had a diameter of 2.257 inches (5.73 centimeters) while the lower platen had a diameter of 3.500 inches (8.89 centimeters). A suitable top platen was purchased from Instron Corporation (Canton, Mass.). The bottom platen was machined. Both platens had flat, smooth finishes suitable for measuring thin plastic or paper sheets, and provision was made to align both platen contact surfaces such that there was no more than a 0.005 inch (0.0127 centimeter) gap between any point on the contact surface of the upper platen and the lower platen when the two platens were brought into physical contact at any other point when mounted on the tensile machine. (It is imperative that the attachment of the platens to the tensile machine and load cell be done in such a manner that there is no mechanical play. This is most easily accomplished through the use of threaded mounting studs with nuts that preload the pins that normally hold fixtures on Synergie tensile machines.) The load cell was properly calibrated according to the manufacturer's instructions (including necessary warm-up periods) and was zeroed with the platen attached.

After the platens were properly installed and aligned, the platens were carefully brought together and loaded to a force of 50 pounds (222 Newtons). At this point, the elongation channel of the tensile machine was zeroed. The tensile machine was then backed-off exactly one inch (2.54 centimeters) under software control and the elongation channel was re-zeroed. This left the platen spacing at one inch (2.54 centimeters) when the tensile frame elongation channel read zero. All subsequent separation measurements were made based on programmed software calculations that corrected for this one-inch offset between actual platen spacing and elongation channel reading. (Use of an offset is a safety precaution known to those skilled in the art; it prevents platen crashing if a machine operator accidentally sends the tensile machine to the ‘home’ position.)

A compression test was initiated by carefully centering a single elongated member on the lower platen. The tensile machine crosshead was then manually moved to a position slightly above the elongated member and a test routine was run through the TestWorks® Software. This test routine compressed the elongated member to a force of 50 pounds (222 Newtons) at a speed of 0.200 inches (0.508 centimeters) per minute. Immediately upon achieving the 50-pound (222 Newtons) load, the tensile frame reversed direction and released compression. The reverse speed was also 0.200 inches (0.508 centimeters) per minute. This completed the test. Data was recorded for both the compression and the rebound portions of the test to allow subsequent calculation of results. Of course, multiple test cycles could be performed as described in materials testing literature.

After a test was completed, the TestWorks® software automatically performed the pertinent calculations. For the purpose of the elongated member compression test, several parameters were calculated from the data. A compression energy value was calculated based on the area under the load/corrected (true) platen-separation curve between the forces of 0.50 pounds (2.22 Newtons) and 50.00 pounds (222 Newtons). A rebound energy value was also calculated based on the area under the load/corrected (true) platen-separation curve from 50.00 pounds (222 Newtons) to 0.50 pounds (2.22 Newtons). (By convention, the rebound energy is a negative value because it represents energy returned to the testing machine by the elongated member.) Both of these values have units of inch-pounds (Joules). In addition, a hysteresis value can be calculated as the algebraic addition of the compression and rebound energies divided by the compression energy. Hysteresis is expressed as a percent.

What is claimed is:

1. A disposable oral hygiene device comprising:
a. an elongated member having a first end and a second end; and
b. a swab secured to said first end, said swab comprising a nonwoven fabric.

2. The disposable oral hygiene device of claim 1 wherein said nonwoven fabric has a base plane and multiple raised areas, said multiple raised areas protruding from said base plane to impart upon said nonwoven fabric a three-dimensional topography.

3. The disposable oral hygiene device of claim 1 wherein said nonwoven fabric comprises overlapping thermoplastic fibers defining an array of hollow projections protruding from said fabric.

4. The disposable oral hygiene device of claim 1 wherein a first swab is secured to said first end, and a second swab is secured to said second end.

5. A disposable oral hygiene device comprising:
a. an elongated member having a first end and a second end, said elongated member comprising a thermoplastic material, said elongated member having a compressive energy of from about 0.226 Joules to about 2.26 Joules; and
b. a swab secured to said first end.

6. The disposable oral hygiene device of claim 5 wherein said elongated member has a compressive energy of from about 0.339 Joules to about 1.13 Joules.

7. The disposable oral hygiene device of claim 5 wherein said elongated member includes a hinge.

8. The disposable oral hygiene device of claim 5 wherein said elongated member includes a permanent bend.

9. The disposable oral hygiene device of claim 5 wherein said elongated member includes a permanent hook.

10. The disposable oral hygiene device of claim 5 wherein said elongated member is hollow.

11. The disposable oral hygiene device of claim 10 wherein said thermoplastic material is polypropylene.

12. The disposable oral hygiene device of claim 10 wherein said elongated member has a wall thickness of from about 0.35 mm to about 0.50 mm.

13. The disposable oral hygiene device of claim 5 wherein said swab comprises a nonwoven fabric.

14. The disposable oral hygiene device of claim 13 wherein said nonwoven fabric comprises overlapping thermoplastic fibers defining an array of hollow projections protruding from said fabric.

15. The disposable oral hygiene device of claim 14 further comprising a dentifrice applied to said swab.

16. A disposable oral hygiene device comprising:
a hollow elongated member having a first end and a second end, said elongated member comprising a polypropylene material, said elongated member having a compressive energy of from about 0.452 Joules to about 0.791 Joules, said elongated member having a wall thickness of from about 0.35 millimeters to about 0.50 millimeters; and
a swab secured to said first end, said swab comprising a nonwoven fabric, said fabric comprising overlapping thermoplastic fibers defining an array of hollow projections protruding from said fabric.

17. A method of making a disposable oral hygiene device comprising:
a. providing an elongated member having a first end;
b. folding a fabric over said first end to create a first layer and a second layer, with said elongated member sandwiched therebetween;
c. securing said fabric to said elongated member; and
d. securing said first layer to said second layer.

18. A method of making a disposable oral hygiene device comprising:
a. providing an elongated member having a first end;
b. winding a fabric around said first end; and
c. securing said fabric to said elongated member.

19. A process of providing oral hygiene care comprising:
providing a disposable oral hygiene device comprising an elongated member having a first end and a second end, wherein a swab is secured to said first end, said swab comprising a nonwoven fabric; and
cleaning a mouth with said disposable oral hygiene device.

20. The process of claim 19 wherein said nonwoven fabric comprises overlapping thermoplastic fibers defining an array of hollow projections protruding from said fabric.

21. The process of claim 19 wherein said elongated member comprises a thermoplastic material, said elongated member having a compressive energy of from about 0.226 Joules to about 2.26 Joules.

22. A process of providing oral hygiene care comprising:
providing a disposable oral hygiene device comprising a hollow elongated member having a first end and a second end, said elongated member comprising a polypropylene material, said elongated member having a compressive energy of from about 0.452 Joules to about 0.791 Joules, said elongated member having a wall thickness of from about 0.35 millimeters to about 0.50 millimeters, wherein a swab is secured to said first end, said swab comprising a nonwoven fabric, said fabric comprising overlapping thermoplastic fibers defining an array of hollow projections protruding from said fabric; and
cleaning a mouth with said disposable oral hygiene device.
